(19) United States
(12) Patent Application Publication
(10) Pub. No.: US 2009/0107651 A1
(43) Pub. Date: Apr. 30, 2009

(54) HEAT EXCHANGER FOR MOTORIZED TRANSPORT, AND MOTORIZED TRANSPORT INCORPORATING A HEAT EXCHANGER

(76) Inventor: Andries Meuzelaar, Poppel (Ravels) (BE)

Correspondence Address: BRYAN CAVE POWELL GOLDSTEIN, ONE ATLANTIC CENTER FOURTEENTH FLOOR, 1201 WEST PEACHTREE STREET NW, ATLANTA, GA, 30309-3488, US

(21) Appl. No.: 11/720,591

(22) PCT Filed: Dec. 2, 2005
(86) PCT No.: PCT/NL05/50061

§ 371 Date: Mar. 25, 2008

(30) Foreign Application Priority Data
Dec. 3, 2004 (NL) 1027646
Jun. 20, 2005 (NL) 1029289

(51) Int. Cl. F01N 5/02; F28D 7/10; B23P 15/26

(52) U.S. Cl. 165/51; 165/164; 29/890.054

(57) ABSTRACT

A heat exchanger for motorised means of transport, comprising at least one heat-conducting pipe through which a first medium is fed and a lining of a thermally conductive, porous structure connected to the pipe via an external side of the pipe, through which a second medium surrounding the pipe is fed. The invention also provides a motorised means of transport provided with such a heat exchanger. The invention furthermore provides a method for applying such a heat exchanger mounted in a motorised means of transport, comprising feeding a first medium through the pipe at a first temperature, and guiding a second medium through the lining at a second temperature, whereby the first temperature and the second temperature are different.

### PRIORITY CLAIM

This patent application is a U.S. National Phase of International Application No. PCT/NL2005/050061, filed Dec. 2, 2005, which claims priority to Netherlands Patent Application No. 1027646, filed Dec. 3, 2004, and Netherlands Patent Application No. 1029289, filed Jun. 20, 2005, the disclosures of which are incorporated herein by reference in their entirety.

### FIELD OF THE INVENTION

The present invention relates to a heat exchanger for motorised means of transport. The present invention also relates to a motorised means of transport provided with such a heat exchanger. The present invention furthermore relates to a method for applying such a heat exchanger mounted in a motorised means of transport. The present invention also relates to two methods for producing such a heat exchanger.

### BACKGROUND OF THE ART

For any motorised means of transport, it is important for the temperature of the engine to remain at an optimum level. In this way it is possible to heat up the engine (in certain icy climates) and to prevent the engine from overheating by cooling the engine. Efficient and intensive cooling of the combustion engine in particular is of essential importance particularly with relatively fast and powerful motorised means of transport, such as (racing) cars, aircraft and specific vessels. For instance, an average Formula 1 racing car has an engine that produces at least 850 bhp (approximately 650 kW) with 10 cylinders at approximately 17,000 revolutions per minute and a maximum of 3000 cc, having an efficiency of approximately 30%. This means that a substantial energy quantity of approximately 1500 kW is converted in an inefficient fashion via, inter alia, oil cooling approximately (120 kW), water cooling approximately (160 kW), gearbox approximately (15 kW), hydraulic system approximately (3 kW), unburnt fuel approximately (225 kW) and emissions via the exhaust approximately (510 kW). Almost half of the usable energy quantity therefore has to be dissipated via heat exchangers (radiators), thus underlining the importance of efficient cooling. In the existing Formula 1 cars, the cooling radiators are positioned in the sides of the car, next to the engine in the so-called internal aerodynamic zone. The internal air rate in these air ducts amounts to approximately 10-15% of the car's velocity, which means that if a car is travelling at 300 km per hour, the air flow rate in the air ducts amounts to approximately 30 to 35 km per hour.

At such restricted air rates (up to approximately 70 km per hour), the heat transfer of the heat exchanger incorporated in the vehicle can be optimised by using the heat exchanger described in the preamble. Such a heat exchanger is described in particular in Dutch patent specification application number NL 1020708, whereby the heat exchanger comprises a porous thermally conductive structure. The number of pores per inch (ppi) of the porous structure thereby lies substantially between 20 and 50, and the thickness of the porous structure thereby lies substantially between 2 and 8 millimetres. Although the radiator known from the aforementioned Dutch patent specification has a significantly improved heat transfer capacity per volume unit per unit of time compared to conventional (laminate) radiators, there is still a need to further optimise the heat transfer capacity (per volume unit). This need arises from the continuous technological development of motorised means of transport, whereby the aim on the one hand is to improve the external aerodynamics of the means of transport, inter alia by reducing the number of resistance-increasing (air) openings in the means of transport, as a result of which more air can be guided alongside the means of transport. The aim on the other hand is to achieve technological performance-driven improvement in existing engines, with engine load per volume unit constantly increasing, thus making it necessary to further improve the known heat exchangers for means of transport.

### SUMMARY OF THE INVENTION

A feature of the present invention is to provide an improved heat exchanger for means of transport, which can be used to transfer more heat per volume unit per unit of time.

To this end, the present invention provides for a heat exchanger of the type known in the preamble, characterised in that the number of pores per inch (ppi) of the porous structure lies substantially between 2 and 20, and in that the thickness of the porous structure lies substantially between 5 and 50 millimetres. The number of pores per inch is thereby less than 20. By adjusting the specifications of the porous structure in the above fashion, the heat exchanger is less suitable for use in conventional positions in a means of transport, for example under the bonnet, as flow rates of the second medium, in particular of air, can only reach up to approximately 20 m/s due to internal aerodynamics, yet based on thorough research it surprisingly turned out that a significantly improved heat transfer can be achieved with this specific combination of properties of the porous structure, if the heat exchanger is positioned outside the so-called internal aerodynamic zone. To this end, the heat exchanger must however usually be positioned substantially outside the means of transport, or at least in the so-called external aerodynamic zone, in order to minimise resistance (produced by the means of transport) with respect to the second medium prior to and after flowing through the heat exchanger. In this way, the flow rate of the second medium through the porous structure will no longer remain restricted to low rates of up to approximately 20 m/s, but significantly higher flow rates of the second medium through the heat exchanger can be achieved, resulting in a significant improvement in the heat transfer capacity per volume of the heat exchanger and per unit of time, and thus in a more intensive cooling of (a part of) the means of transport. The heat exchanger is particularly suitable for use with means of transport that can travel at relatively high cruising speeds from approximately 30 m/s to approximately 310 m/s, whereby the heat exchanger is thus also exposed to such speeds, and whereby the flow rate of the second medium through the heat exchanger approaches the current cruising speed of the means of transport. It is particularly advantageous in comparison with the known heat exchangers, to use the heat exchanger only when the means of transport travels at these higher cruising speeds and when the heat exchanger is used in the external aerodynamic zone. If the means of transport moves slowly at a cruising speed of up to 20 m/s, the advantage of a relatively intensive heat transfer of the heat exchanger according to the invention will usually no longer be apparent. The heat exchanger preferably comprises means of attachment to attach the heat exchanger to the motorised means of transport in such a way that the feeding of the second medium through the heat exchanger is substantially only hindered by the heat exchanger, and not by the means of transport itself. It should be noted that the heat exchanger will generally be used for cooling one or more combustion engines of a means of transport. However it is also possible to envisage using the heat exchanger according to the invention to cool auxiliary equipment requiring cooling in the means of transport, such as for example an air-conditioning unit or gearbox.

The thermally conductive structure is preferably formed by means of a metal foam. Due to its relatively large external surface area, a metal foam is advantageous in that it has a particularly good temperature-conducting capacity, enabling the temperature exchange, or at least the heat exchange, to be maximised between the first medium and the second medium. In a particular preferred embodiment, the metal foam is produced out of at least one of the following metals: copper, nickel, brass and aluminium. It is also possible to envisage producing the metal foam out of an alloy. The lining is preferably provided with a non-corroding metal or a metal oxide, to increase the useful life of the heat exchanger by preventing the heat exchanger from degrading or at least resisting the degradation thereof. As the heat exchanger according to the invention is particularly arranged to be positioned in the external aerodynamic zone of a means of transport, the heat exchanger is exposed to relatively high air flow rates of up to approximately 310 m/s. To increase the resistance of the heat exchanger, the lining is preferably provided with a resistance-increasing substance, such as a coating produced out of titanium and/or carbon for example. The heat-conducting pipe is preferably produced out of a metal, in particular at least one of the following metals: Copper, nickel, brass, stainless steel and aluminium. A particular advantage of aluminium is that it has a relatively low density, which will usually be advantageous particularly for specific means of transport, such as (racing) cars and aircraft.

In a preferred embodiment, the wire thickness of the porous structure lies at least substantially between 15 and 500 micrometres, more preferably between 30 and 500 micrometres, in particular between 50 and 400 micrometres, and more particularly between 60 and 350 micrometres. Such wire thickness can further increase the efficiency of the heat transfer between the first medium and the second medium.

In a further preferred embodiment, the outer hydraulic diameter of the pipe lies between 2 and 50 millimetres, in particular between 10 and 45 millimetres, and more particularly between 15 and 40 millimetres. As reference is only made to the hydraulic diameter, the pipe can be designed with very different geometries. For instance, in addition to cylindrical pipes, fin-shaped pipes or other shapes of pipe are also possible, whereby the hydraulic diameter lies within the above limits.

A side of the lining facing the pipe preferably makes at least substantially complete thermal contact with the pipe. The heat transfer can thus be optimised between the pipe and the porous structure or between the first medium and the second medium.

In a preferred embodiment, the lining is connected to the pipe through the medium of a thermally conductive means. The thermally conductive means can be very diverse in nature.

The thermally conductive means can for example be formed by means of a thermally conductive adhesive, (solder) paste, thermally conductive metal layer, etcetera. The thermally conductive means can be applied in various ways, for example by vacuum evaporation or by an electrodeposition process.

In a further preferred embodiment, the lining is configured out of at least one strip of material that is applied around the pipe in a spiral formation. For instance the use of relatively narrow strips of metal will suffice, that can be applied around the pipe in a relatively simple fashion.

It is generally important to be able to substantially fix the relative orientation between the heat exchanger and the means of transport, in order to prevent damage to the heat exchanger and/or means of transport during use. It is thus advantageous for the heat exchanger to comprise a frame to secure the pipe. The frame can thereby strengthen the heat exchanger, thus preventing damage to the heat exchanger as well as to the means of transport, for example as a result of the pipe vibrating during use. In a particular preferred embodiment, the frame is provided with means of attachment for attaching the heat exchanger to the means of transport in a detachable fashion. The means of attachment are thereby preferably sufficiently robust to be able to substantially fix the relative orientation of the means of transport and the heat exchanger, even if the means of transport is travelling at relatively high velocities. Feed pipes and/or output pipes of the heat exchanger for respectively feeding or outputting the first medium thereby preferably form part of the means of attachment and/or are incorporated therein.

The heat exchanger preferably comprises more than one interconnected pipe, in order to increase the overall transfer of heat. In a particular preferred embodiment, the pipes are positioned at a distance from each other, whereby guiding elements are mounted between the pipes to steer the second medium towards the lining. The guiding element can thereby be designed in very diverse ways.

In order to use the heat exchanger according to the invention relatively efficiently in an external aerodynamic zone, it is advantageous for the heat exchanger to be at least partially integrated in a part of the means of transport situated on an outer side, such as for example a part of the bodywork and/or a part of the chassis. The part of the bodywork and/or part of the chassis can thus be formed, albeit at least partially, by the heat exchanger. Such a part of the bodywork can thus for example be formed by a wing and/or roof part of a vehicle, in particular a car. The present invention therefore also relates to an exterior part of a means of transport, or at least an exterior part of the bodywork and/or part of the chassis, whereby the part of the means of transport is formed, albeit at least partially, by the heat exchanger according to the invention.

In a preferred embodiment, the heat exchanger is designed such that the heat exchanger is arranged for generating an upwards and/or downwards pressure while the second medium feeds through the heat exchanger. The heat exchanger according to the invention thus acquires an additional functionality, namely the functionality of generating an upwards and/or downwards lift as desired, in turn affecting the movement and/or positioning of the corresponding means of transport. In this way, an upwards lift can for example be applied for getting an aircraft to ascend, while a downwards lift can for example be applied for improving the road holding in vehicles, in particular in racing cars. The heat exchanger can thereby for example be integrated in a wing for an aircraft or in a spoiler or wing of a car.

In a preferred embodiment, the heat exchanger is arranged for guiding the second medium, and more preferably the heat exchanger as such is substantially streamlined in design or is at least arranged for streamlining the second medium, enabling the aerodynamic resistance caused by the second medium while the means of transport is in motion to be reduced. Truck-trailer combinations in particular are generally subject to significant aerodynamic resistances during freight transport as a result of the relatively robust trailers that are usually attached to a truck. By positioning the heat exchanger according to the invention as a spoiler above a cab of the truck for example, it is possible to realise a relatively efficient cooling of the combustion engine of the truck on the one hand, while substantially guiding the longitudinal flow of the second medium relatively efficiently along the trailer on the other, in turn making it possible to reduce the aerodynamic resistance and thus fuel consumption of the truck-trailer combination.

In a preferred embodiment, at least a part of the pipe surface facing the second medium is substantially flush in design. In this way it is possible to produce the at least one pipe relatively cheaply out of existing materials that are tube-shaped and/or in sheet form. However, if an increase in the contact surface between the first medium and the second medium is nevertheless desired, at least a part of the pipe surface facing the second medium is preferably contoured in design. However, the contouring does not give rise to a three-dimensional porous surface structure. However in that case, the porous structure will be mounted on the contoured outer surface of the pipe. The contouring will generally comprise several curvatures, waves or other types of curve applied in the pipe. The pipe itself is preferably substantially solid in design, provided that the pipe is still arranged for feeding through the first medium. Only one wall forming part of the pipe, said wall de facto separating the first medium from the second medium, will thereby be substantially solid in design.

In order to generate an upwards pressure or downwards pressure, the cross-section of at least a part of the heat exchanger preferably substantially forms a wing profile. A wing profile forms an asymmetric profile (of a drop), which can be used to generate a vertical lift (upwards or downwards) relatively efficiently and effectively, depending on the orientation of the wing profile.

In a preferred embodiment, the heat exchanger is provided with a basic structure, on a circumferential edge of which at least some of the pipes are mounted. The cross-section of the basic structure thus preferably forms a wing profile, on the circumferential edge of which the pipes can be positioned substantially parallel and adjacent to each other. The basic structure can be hollow in design, in order to minimise the mass of the heat exchanger, but it can also be provided with a functional filling, such as for example an impact-resistant and/or sound-insulating material. It is also possible to envisage providing the basic structure with one or more air inlets, enabling the second medium to also flow along a part of the heat exchanger pipes facing the basic structure. It is furthermore possible for the second medium—usually heated up during the heat exchange with the first medium—to be guided towards the engine of the means of transport. Supplying heated air to the engine of the means of transport is inter alia advantageous in that air can be permanently supplied to the engine under more or less the same conditions, and is less sensitive to momentary weather fluctuations.

The present invention also relates to a motorised means of transport provided with at least one heat exchanger according to the present invention, whereby the heat exchanger is positioned at least substantially outside the means of transport, or at least in the external aerodynamic zone of the means of transport. The external aerodynamic zone usually closely follows the contours of the means of transport. However, it is also possible to envisage providing the means of transport with an open air shaft extending in the longitudinal direction of the means of transport, with the heat exchanger according to the invention being positioned in said air shaft. It will be possible for air to move in such an air shaft at an air flow rate substantially equal to the cruising speed of the means of transport, with said shaft mounted in the vehicle also lying within the external aerodynamic zone. The heat exchanger preferably extends on several sides with respect to the means of transport, and can thereby form a side wing that is attached to either side of the means of transport, such as for example a racing car, thus achieving greater stability with respect to the means of transport when it is in transit. The conventional separate air shaft(s) for taking in the second medium therefore no longer need to be applied. The heat exchanger preferably extends substantially cross-wise to the longitudinal centre line of the means of transport, enabling the contact surface of the heat exchanger with the second medium to be efficiently optimised. In a preferred embodiment, the heat exchanger substantially extends in a direction forming an angle with the horizontal plane. In a particular preferred embodiment, this angle can be adjusted, enabling the cooling capacity of the heat exchanger according to the invention and the upwards or downwards pressure generated by the heat exchanger while the means of transport is in motion to be regulated. The means of transport preferably comprises at least one profile, said profile being partially formed by the heat exchanger. The profile can thereby relate to a (car) wing, as well as to a wing of a vessel or aircraft. In a particular preferred embodiment, the means of transport is provided with more than one heat exchanger, whereby the orientation of each heat exchanger can be independently modified, in order to generate an upwards and/or downwards pressure. It is therefore possible to envisage for example one of the heat exchangers generating an upwards pressure, while the other heat exchanger (simultaneously) generates a downwards pressure, enabling the means of transport to take a bend. This could be advantageous for the stability of the means of transport in the event of strong (side) winds.

The motorised means of transport can be very diverse in nature, but it is preferably arranged to travel at relatively high cruising speeds (>30 m/s), thus making it possible to achieve the advantage of a significantly improved heat transfer of the developed heat exchanger. The means of transport is preferably formed by one of the following means of transport: a vessel, an aircraft, and a vehicle, in particular a car.

The present invention thereupon relates to a heat exchanger according to the present invention for use in conjunction with a motorised means of transport, whereby the heat exchanger is positioned substantially outside the means of transport, or at least substantially in the external aerodynamic zone. The present invention furthermore relates to the use of a heat exchanger according to the invention for cooling and/or heating up at least a part of a means of transport, substantially outside the means of transport. The cooling process will thereby usually, but not necessarily, relate to the cooling of a combustion engine of the means of transport. Advantages of the novel use of the heat exchanger according to the invention and the particular specifications of the heat exchanger according to the invention required for this purpose have already been described in detail above.

The present invention furthermore relates to a method according to the type referred to in the preamble, characterised in that the second medium is guided through the lining in accordance with step B) at a flow rate lying substantially between 30 and 310 metres per second. Precisely at these relatively high rates, these particular specifications of the porous structure of the heat exchanger result in a significantly improved heat transfer per volume unit of heat exchanger per unit of time. The first medium will generally be formed by a liquid, in particular water or oil, and the second medium will be formed by a gas, in particular air, or by a liquid. A relatively cool second medium will be applied to cool down the first medium, for example with respect to cooling combustion engines. However, it is also possible to envisage blowing steam for example through the lining, in order to warm up a relatively cool liquid contained in the pipe, such as for example oil. It is thus possible to heat up a relatively cold engine in an icy climate in a relatively efficient fashion, before it is started up.

The method for producing such a heat exchanger comprises the following steps: A) applying a soldering means to the outer side of a pipe, B) affixing a porous structure around the pipe enclosing the soldering means, whereby the number of pores per inch (ppi) of the porous structure lies substantially between 2 and 20, and whereby the thickness of the porous structure lies substantially between 5 and 50 millimetres, C) liquefying the soldering means, and D) having the soldering means solidify. While the molten soldering means is solidifying according to step D), the actual bonding takes place between the pipe and the porous structure, whereby the contact between the pipe and a side of the porous structure facing the pipe can be maximised. The liquefying of the soldering means according to step C) thereby preferably takes place by heating the soldering means. Such a process of heating can take place indirectly, for example by exerting an electrical voltage, preferably instantaneously and for a very short time, but it can also take place directly, by increasing the ambient temperature of the soldering means. It is however also possible to envisage applying other types of methods for bonding the pipe and porous structure to each other, such as induction soldering or chemical soldering. An alternative method for producing such a heat exchanger comprises the following steps: A) placing a pipe in contact with a porous structure, whereby the number of pores per inch (ppi) of the porous structure lies substantially between 2 and 20, and whereby the thickness of the porous structure lies substantially between 5 and 50 millimetres, and B) bonding the pipe and the porous structure to each other by means of an electrical (vacuum evaporation) and/or chemical (electrodeposition) process.

### BRIEF DESCRIPTION OF THE DRAWINGS

Further features of the invention will emerge from non-restrictive embodiments shown in the following figures:

FIG. 1 a front view of a heat exchanger according to on exemplary embodiment of the present invention,

FIG. 2 a top view of a racing car provided with a heat exchanger according to the invention,

FIG. 3 a detailed three-dimensional view of a Formula 1 car provided with more than one heat exchanger according to the invention,

FIG. 4 a three-dimensional view of another Formula 1 car provided with more than one heat exchanger according to the invention,

FIG. 5 a three-dimensional view of a supersonic aircraft provided with more than one heat exchanger according to the invention, and

FIG. 6 a three-dimensional view of a truck-trailer combination provided with a heat exchanger according to the invention.

### DETAILED DESCRIPTION OF THE PREFERRED EMBODIMENTS

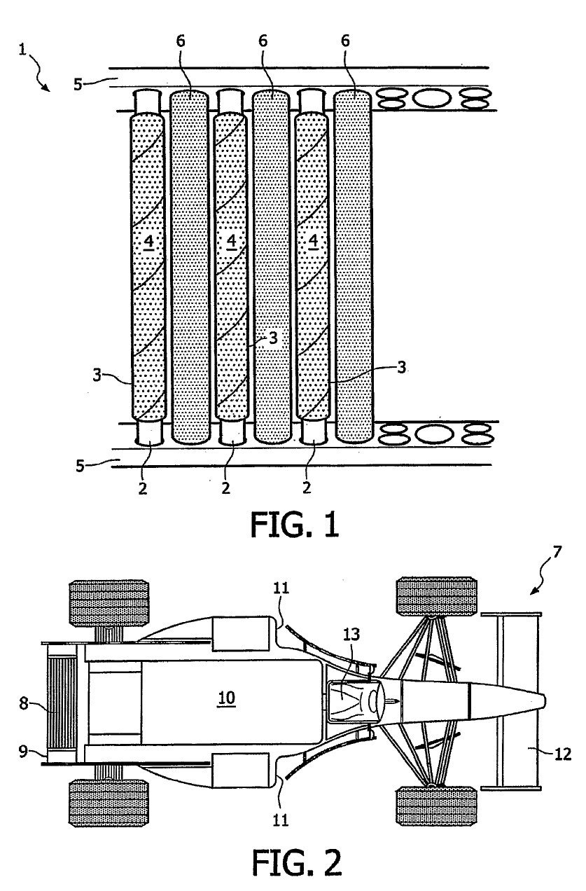

FIG. 1 shows a front view of a heat exchanger 1 according to the invention. The heat exchanger 1 comprises more than one pipe 2, through which a medium to be cooled down, such as for example water or oil, can be guided. Each pipe 2 is thereby lined with a thermally conductive three-dimensional open-cell metal foam 3. A relatively cool (gaseous) medium, in particular cold air, can be guided through the metal foam 3, which is used to cool down the medium to be cooled down. In this embodiment, the metal foam 3 is in the form of a strip 4 helically wound around the pipe 2. The metal foam 3 is connected to the pipe 2 using means known in this field, such as for example by means of thermally conductive adhesive, a thermally conductive paste, a soldering process or by vacuum evaporating a bonding and heat-conducting metal layer, or by means of an electrodeposition process. It is important in this respect for there to be a good thermal contact between the three-dimensional metal foam 3 and the pipe 2. A heat-conducting metallic connection is preferably used, preferably on the basis of nickel, copper or aluminium. As an option, it is also possible to apply a non-corroding metal or metal oxide layer to the lining 3. The metal foam 3 is preferably produced out of nickel, copper or aluminium or an alloy thereof. It is also possible for the metal foam 3 to comprise layered combinations of the materials referred to above. The metal foam 3 has a volume porosity that lies between 50 nd 90% (500 g/m²-5000 g/m²). The ppi content (pores per inch) of the metal foam 3 used in this embodiment lies between 0 and 20 ppi, in particular between 2 and 15 ppi, and more particularly between 5 and 10 ppi. The thickness of the metal foam 3 lies between 5 and 30 millimetres, in particular between 10 and 30 millimetres, and more particularly between 15 and 20 millimetres. The pipes 2 are clamped into position at their head ends by two distribution pipes 5 forming part of a frame for the medium to be cooled down. A number of guiding elements 6 are mounted between the pipes 2, guiding the second medium, such as air, along the porous metallic lining 3. The heat exchanger 1 is arranged to be positioned outside, or at least adjacent to the outer side of a means of transport, whereby a feed side and an output side for the air flow to be cooled are preferably freely situated, enabling the relatively cool gaseous medium to flow through the heat exchanger at high rates (>30 m/s), in turn enabling a relatively efficient cooling of the liquid medium flowing through the pipes 2 (without hindrance).

FIG. 2 shows a top view of a racing car 7 provided with a heat exchanger 8 according to the invention. The heat exchanger 8 thereby forms, at least a substantial part of, a rear spoiler 9 of the racing car 7. The heat exchanger 8 itself thereby has a reliable aerodynamic design. The spoiler 9 extends cross-wise in a direction that forms a specific angle with the horizontal plane, causing the heat exchanger 8, or at least by the spoiler 9, to exert a downwards force while the racing car 7 is in motion, in turn improving the road holding of the racing car 7. The heat exchanger 8 is structurally similar to the heat exchanger 1 shown in FIG. 1. By positioning the heat exchanger 8 externally, it is possible to realise a relatively efficient cooling of an engine 10 of the racing car 7. The engine 10 is thus provided with air inlets 11 that are positioned laterally with respect to the engine 10 of the racing car 7, in particular for the combustion of fuel in the engine 10. As an option it is possible to position an additional heat exchanger (not shown) near each air inlet 11, a front spoiler 12 and/or a driver's cab 13 of the racing car 7.

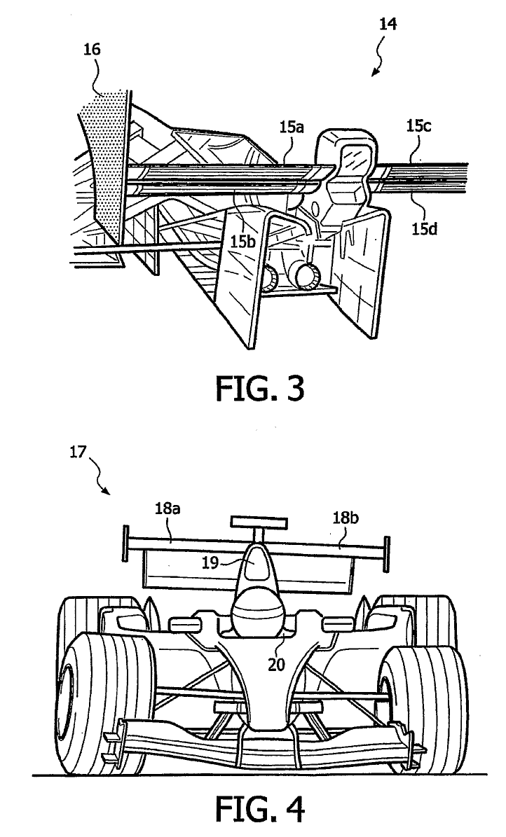

FIG. 3 shows a detailed three-dimensional view of a Formula 1 car 14 provided with more than one heat exchanger 15a, 15b, 15c, 15d according to the invention. The heat exchangers 15a, 15b, 15c, 15d are thereby arranged in pairs and form an integral part of a rear spoiler 16 of the car 14. In this way it is possible to realise a relatively efficient engine cooling of the Formula 1 car 14. Further advantages of the structure shown have already been described in detail above.

FIG. 4 shows a three-dimensional view of another Formula 1 car 17 provided with more than one heat exchanger 18a, 18b according to the invention. The heat exchangers 18a, 18b are thereby attached on either side to a high air inlet 19 just behind the driver's cab 20 of the car 17. The heat exchangers 18a, 18b can independently be rotated axially, in order to realise an upwards and/or downwards pressure, which is advantageous for the road holding of the car 17. It is thereby possible to envisage one heat exchanger 18a being oriented such that a downwards pressure is realised and another heat exchanger 18b being simultaneously oriented such that an upwards pressure is realised, in order to optimise the road holding of the car 17 when taking bends and/or facilitating the ability to absorb any side wind. The design of the heat exchanger 18a, 18b is structurally similar to the heat exchanger 1 shown in FIG. 1. Advantages of the external positioning of the heat exchangers 18a, 18b have already been described in detail above.

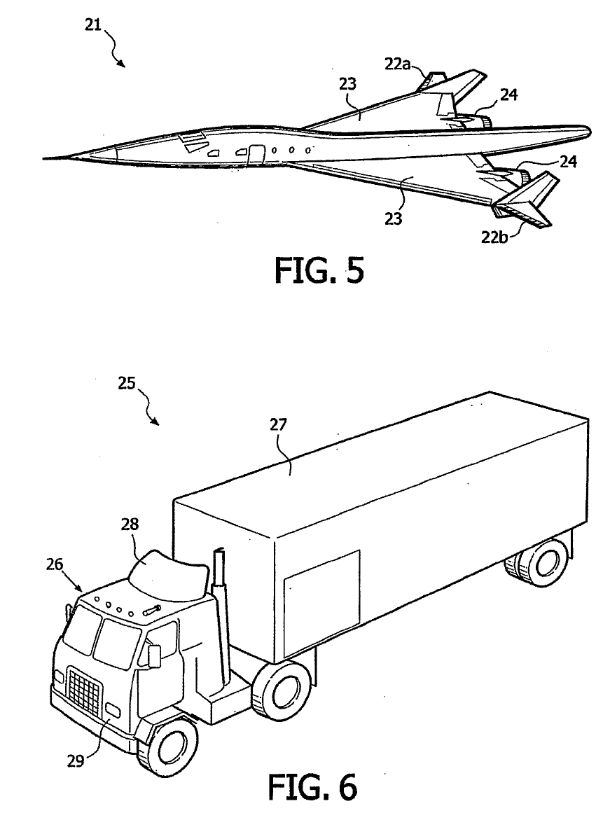

FIG. 5 shows a three-dimensional view of a supersonic aircraft 21 provided with more than one heat exchanger 22a, 22b according to the invention. The heat exchangers 22a, 22b each comprise an assembly of pipes lined with metal foam for cooling heat-producing auxiliary equipment used in the aircraft 21, such as for example an air-conditioning unit. The metal foam thereby has the specifications as set out in the description pertaining to FIG. 1. As the heat exchangers 22a, 22b are exposed to high air rates (>331 m/s), each heat exchanger 22a, 22b is provided with a resistance-increasing protective coating. In the embodiment shown, each heat exchanger 22a, 22b is incorporated in a rigid extremity of wings 23 forming part of an aircraft 21. In the embodiment shown, the heat exchangers 22a, 22b are not arranged for cooling turbine engines 24 incorporated in the wings 23. In an alternative embodiment, the heat exchangers can be incorporated in wing valves (not shown) forming part of the wings 23.

FIG. 6 shows a three-dimensional view of a combination 25 of a truck 26 and a trailer 27 coupled to the truck 26, whereby the truck 26 is provided with a heat exchanger 28 according to the invention. The heat exchanger 28 is positioned on top of a driver's cab 29 of the truck and is arranged for cooling a combustion engine of the truck 26. Furthermore, the heat exchanger 28 forms an angle with the horizontal plane, enabling the heat exchanger 28 to also be considered as a spoiler for guiding air flowing alongside the heat exchanger 28 while the combination 25 is in transit, in turn making it possible to significantly reduce the air resistance actually caused by the trailer 27 which is relatively high compared to the driver's cab 29, while the combination 25 is in transit.

It should be noted that the invention is not restricted to the embodiments shown and described herewith, and that a large number of variants, which are obvious for the person skilled in this art, are possible within the scope of the accompanying claims. All patents, patent applications and other publications referred to herein are incorporated by reference in their entirety.

1. A heat exchanger for motorised means of transport, comprising:
a. at least one heat-conducting pipe for feeding through a first medium; and
b. a lining of a thermally conductive, porous structure connected to the pipe via an external side of the pipe, through which a second medium surrounding the pipe is fed,
wherein the number of pores per inch (ppi) of the porous structure is between about 2 and about 20, and wherein the thickness of the porous structure is between about 5 and about 50 millimetres.

2. The heat exchanger of claim 1, wherein the thermally conductive structure is formed by a metal foam.

3. The heat exchanger of claim 2, wherein the metal foam is produced out of at least one material selected from the group comprising copper, nickel, brass and aluminium.

4. The heat exchanger of claim 1, wherein the lining is at least partially produced out of a non-corroding metal.

5. The heat exchanger of claim 1, wherein the lining is provided with a resistance-increasing substance.

6. The heat exchanger of claim 1, wherein the wire thickness of the porous structure is at least substantially between about 30 and about 500 micrometres.

7. The heat exchanger of claim 1, wherein the hydraulic diameter of the pipe is at least substantially between about 2 and about 50 millimetres.

8. The heat exchanger of claim 1, wherein a side of the lining facing the pipe makes at least substantially complete thermal contact with the pipe.

9. The heat exchanger of claim 1, wherein the lining is connected to the pipe through the medium of a thermally conductive means.

10. The heat exchanger of claim 1, wherein the lining is configured out of at least one strip of material that is applied around the pipe in a spiral formation.

11. The heat exchanger of claim 1, wherein the heat exchanger comprises a frame to secure the pipe.

12. The heat exchanger of claim 11, wherein the frame is provided with means of attachment for attaching the heat exchanger to the means of transport.

13. The heat exchanger of claim 1, wherein the heat exchanger comprises more than one interconnected pipe.

14. The heat exchanger of claim 13, wherein the pipes are positioned at a distance from each other, whereby guiding elements are mounted between the pipes to steer the second medium towards the lining.

15. The heat exchanger of claim 1, wherein the heat exchanger is arranged for generating an upwards and/or downwards pressure while the second medium feeds through the heat exchanger.

16. A motorized means of transport provided with at least one heat exchanger comprising
a. at least one heat-conducting pipe for feeding through a first medium; and
b. a lining of a thermally conductive, porous structure connected to the pipe via an external side of the pipe, through which a second medium surrounding the pipe is fed,
wherein the number of pores per inch (ppi) of the porous structure is between about 2 and about 20, wherein the thickness of the porous structure is between about 5 and about 50 millimeters, whereby the heat exchanger is positioned at least substantially outside the means of transport.

17. The means of transport of claim 16, wherein the heat exchanger extends substantially cross-wise to the longitudinal center line of the means of transport.

18. The means of transport of claim 16, wherein the heat exchanger substantially extends in a direction forming an angle with the horizontal plane.

19. The means of transport of claim 16, wherein the means of transport comprises at least one externally positioned profile, said profile being at least partially formed by the heat exchanger.

20. The means of transport of claim 16, wherein the means of transport is a vessel, an aircraft, and a vehicle.

21. The heat exchanger of claim 1 for use in conjunction with a motorized means of transport, whereby the heat exchanger is positioned substantially outside the means of transport.

22. The use of a heat exchanger of claim 1 for cooling and/or heating up at least a part of the means of transport, substantially outside the means of transport.

23. A method for using a heat exchanger mounted in a motorized means of transport, the heat exchanger comprising (a) at least one heat-conducting pipe for feeding through a first medium: and (b) a lining of a thermally conductive, porous structure connected to the pipe via an external side of the pipe, through which a second medium surrounding the pipe is fed, wherein the number of pores per inch (ppi) of the porous structure is between about 2 and about 20, and wherein the thickness of the porous structure is between about 5 and about 50 millimeters, the method comprising:
a. feeding a first medium through the pipe at a first temperature, and
b. guiding a second medium through the lining at a second temperature,
whereby the first temperature and the second temperature are different, and
wherein the second medium is guided through the lining in accordance with step b. at a flow rate of at least substantially between about 30 and about 310 meters per second.

24. A method for producing a heat exchanger, the heat exchanger comprising (a) at least one heat-conducting pipe for feeding through a first medium; and (b) a lining of a thermally conductive, porous structure connected to the pipe via an external side of the pipe, through which a second medium surrounding the pipe is fed, wherein the number of pores per inch (ppi) of the porous structure is between about 2 and about 20, and wherein the thickness of the porous structure is between about 5 and about 50 millimetres, the method comprising:
a. applying a soldering means on an outer side of a pipe;
b. affixing a porous structure around the pipe enclosing the soldering means, whereby the number of pores per inch (ppi) of the porous structure lies substantially between 2 and 20, and whereby the thickness of the porous structure lies substantially between 5 and 50 millimeters;
c. liquefying the soldering means; and
d. solidifying the soldering means.

25. A method for producing a heat exchanger, the heat exchanger comprising (a) at least one heat-conducting pipe for feeding through a first medium; and (b) a lining of a thermally conductive, porous structure connected to the pipe via an external side of the pipe, through which a second medium surrounding the pipe is fed, wherein the number of pores per inch (ppi) of the porous structure is between about 2 and about 20, and wherein the thickness of the porous structure is between about 5 and about 50 millimetres, the method comprising:
a. placing a pipe in contact with a porous structure, whereby the number of pores per inch (ppi) of the porous structure is substantially between about 2 and about 20, and whereby the thickness of the porous structure is substantially between about 5 and about 50 millimetres, and
b. bonding the pipe and the porous structure to each other by means of an electrical (vacuum evaporation) and/or chemical (electrodeposition) process.
